(19) United States
(12) Patent Application Publication
(10) Pub. No.: US 2009/0212584 A1
(43) Pub. Date: Aug. 27, 2009

(54) CARGO MANAGEMENT SYSTEM

(76) Inventor: Dean E. Hill, Arden, NC (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/390,335

(22) Filed: Feb. 20, 2009

Related U.S. Application Data
(60) Provisional application No. 61/030,517, filed on Feb. 21, 2008.

(51) Int. Cl. B60R 7/08

(52) U.S. Cl. 296/37.5

(57) ABSTRACT

A cargo management system for a vehicle with a top surface having a removable fastener, such as a hook-and-loop fastener, to accommodate a plurality of removable chocks for preventing the shifting of cargo. In one embodiment, the cargo management system comprises a plurality of panel segments connected by hinges. In another embodiment, the cargo management system comprises a plurality of detachable panel segments connected by a lock mechanism. The cargo management system may include a bottom surface having a non-skid material attached thereto to prevent movement of the cargo management system within the vehicle.

### CROSS-REFERENCE TO RELATED APPLICATION

This application claims the benefit of U.S. Application No. 61/030517, filed Feb. 21, 2008, the disclosure of which is hereby expressly incorporated by reference in its entirety.

### BACKGROUND

The subject matter disclosed herein is generally in the field of vehicle accessories and, more particularly, in the field of apparatus for accommodating and securing items in the cargo area of a vehicle.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A cargo management system for a vehicle is provided, the cargo management system comprising a plurality of panels that are interconnected to define a multi-segment panel. A plurality of first portions of a releasable fastener are affixed to a top surface of one of the plurality of panels. A plurality of chocks are provided, and each of a plurality of second portions of a releasable fastener are affixed to a side of one of the plurality of chocks. The second portions releasably adhere to the first portions of the releasable fasteners, such that the plurality of chocks may be positioned and releasably attached to the multi-segment panel. Each of a plurality of pieces of a skid-resistant material are affixed to a bottom surface of one of the plurality of panels.

In other embodiments, a cargo management system for a vehicle is provided, the cargo management system comprising a multi-segment panel which comprises a plurality of hingedly connected panel segments and means for hingedly connecting the plurality of panel segments. A plurality of chocks is provided, and a first portion of a releasable fastener is fixedly attached to each of the plurality of chocks. A second portion of the releasable fastener is fixedly attached to a top surface of the multi-segment panel, such that the plurality of chocks are selectively positionable on the top surface of the multi-segment panel. A skid-resistant material is fixedly attached to a bottom surface of the multi-segment panel.

In other embodiments, a cargo management system for a vehicle is provided, the cargo management system comprising a plurality of chocks, each chock having a side comprising a first portion of a hook-and-loop fastener. The cargo management system also comprises a plurality of panel segments. Each panel segment includes a substantially smooth upper surface having strips of a second portion of a hook-and-loop fastener attached thereto, such that the upper surface releasably engages the plurality of chocks. Each panel segment also includes a lower surface having a skid-resistant material attached thereto. The cargo management system also comprises means for detachably connecting each of the plurality of panel segments to at least one other of the plurality of panel segments.

### BRIEF DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 is an environmental view showing a cargo management system being inserted into a vehicle according to various embodiments of the present disclosure;

FIG. 2 is a perspective view of the cargo management system shown in FIG. 1;

FIG. 3 is a perspective view of an exemplary chock for the cargo management system shown in FIG. 1;

FIG. 4 is a perspective view of a bottom surface of a multi-segmented panel of the cargo management system shown in FIG. 1;

FIG. 5 is a simplified side view of the multi-segmented panel of the cargo management system of FIG. 1, shown in a folded position;

FIG. 6 is an exploded perspective view of portions of a bottom side of a cargo management system having detachable segments, according to a second embodiment of the present disclosure;

FIG. 7 is an exploded perspective view of portions of a top side of the cargo management system shown in FIG. 6;

FIG. 8 is a perspective view of the assembled cargo management system shown in FIG. 6;

FIG. 9A is an exploded detail view of a locking mechanism for connecting detachable panel segments of the cargo management system shown in FIG. 6;

FIG. 9B is a bottom detail view showing the locking mechanism for connecting detachable panel segments of the cargo management systems shown in FIG. 6; and

FIG. 9C is a perspective detail view of the cargo management system shown in FIG. 6 with a stored hex wrench tool used to positively lock the cargo management system to an associated vehicle hard point.

### DETAILED DESCRIPTION

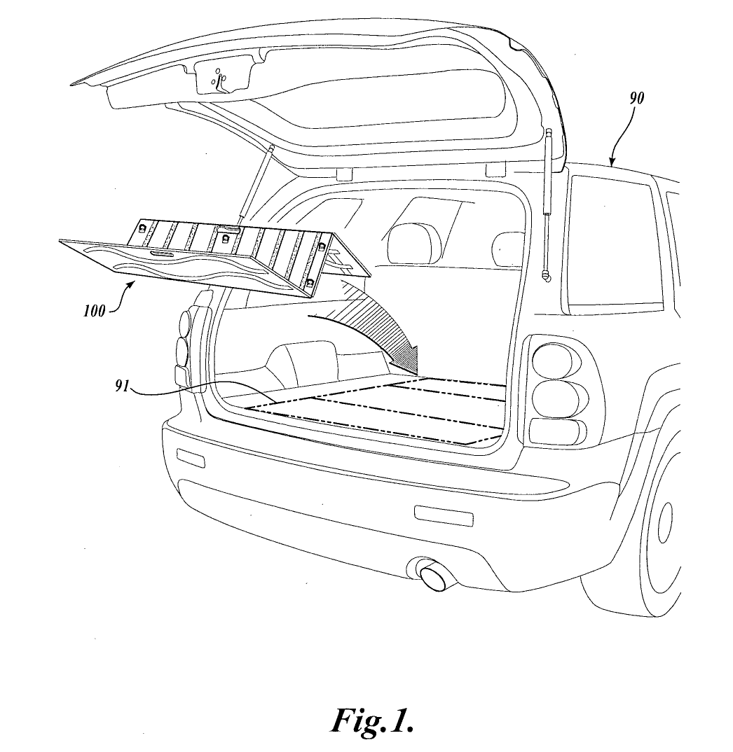

FIG. 1 is a perspective environmental view of an exemplary embodiment of a cargo management system 100 that is insertable into a vehicle 90, such as an SUV. While an SUV is depicted and described in FIG. 1, embodiments of the cargo management system 100 may be adapted to fit other types of vehicles with enclosed cargo areas, such as pickup trucks, hatchbacks, minivans, and so on. The depicted embodiment of the cargo management system 100 is shown being unfolded from a folded, stored configuration to be deployed in an indicated section of a cargo area 91 of the vehicle 90.

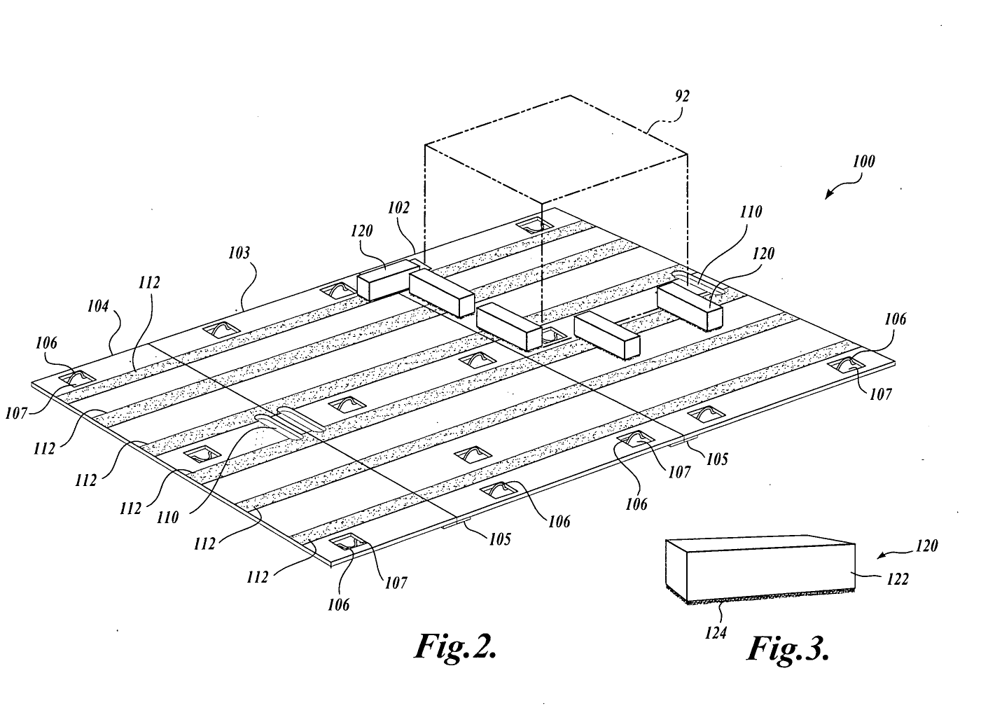

As shown in FIG. 2, once deployed, boxes, bags, or other cargo 92 may be positioned on the cargo management system 100, which preferably provides a smooth, level, low-friction surface to facilitate sliding during loading while protecting the vehicle floor. Chocks 120, described further below, may then be positioned around the cargo to prevent it from sliding during transportation. In some embodiments, securing straps, bungee cords, or the like may also be attached to two or more hard mounts 106 and over the cargo to further secure the cargo. When not in use, the cargo management system 100 may be removed from the vehicle 90, folded, and stored. It is contemplated that one or more bags, such as a canvas storage bag, may be provided to conveniently store the cargo management system 100 when not in use.

One advantage of the present system is that the upper surface of the cargo management system 100 provides a substantially flat and level surface during use, which will facilitate the loading and retention of cargo by allowing packages to be readily pushed or slid along the panel. Also, the smooth surface of the cargo management system 100 reduces the opportunities for losing small items, and allows debris to be easily swept away. The cargo management system 100 is easily deployable and removable, without requiring elaborate and time-consuming installation procedures. In particular, the chocks 120 provide a very quick and infinitely adjustable securement mechanism. The placement of the chocks 120 is not restricted to a finite number of orientations or discrete positions, but can be placed to directly abut packages of any size, in any location, and of any shape. When the chocks 120 are suitably positioned about a package, the package will generally be prevented from shifting during driving, reducing distraction to the driver and protecting the package and the vehicle. For larger, heavier, and/or irregularly shaped packages, means are provided for supplementing the retention function of the chocks 120, for example, with straps or the like.

It is contemplated that the cargo management system 100 may be readily customized to a particular vehicle cargo area, for example, by suitably sizing and shaping the cargo management system 100, and by providing suitable apertures for accommodating vehicle hard mounts, seat rails, etc., of a particular vehicle model. In some embodiments, the cargo management system 100 may be made predominantly from aesthetically pleasing material, such as a finished wood or an ornate plastic, to provide a very attractive addition to any vehicle.

FIG. 2 is a perspective view of the cargo management system 100 in a deployed configuration. The cargo package 92 is shown in phantom. The cargo management system 100 comprises a multi-segmented panel, having a first panel segment 102, a second panel segment 103, and a third panel segment 104. Each panel segment 102, 103, 104 may be made of any suitable material, such as plastic, solid wood, plywood, metal, and so on. Preferably, the panel segments 102, 103, 104 are formed from a rigid or substantially rigid material, and the top surface is relatively smooth and level. In some embodiments, the cargo management system may comprise more or less than three panel segments. The panel segments 102, 103, 104 of the cargo management system 100 may include channels, apertures, and/or cutouts to accommodate features or protrusions in the cargo area 91 of the vehicle 90, such as seat rails, wheel wells, and so on.

The panel segments 102, 103, 104 are interconnected such that the multi-segment panel may be conveniently folded to help ease installation and storage. In one embodiment, the panel segments 102, 103, 104 are interconnected with hinges 105. Hinges 105 may be any type of hinge that allows the panel segments 102, 103, 104 to be securely and foldably fastened to one another, and preferably are a type of hinge that allows an upper surface of the multi-segment panel to remain smooth. In one embodiment, hinges 105 may comprise piano-type hinges that extend substantially along an entire width of the multi-segment panel, as shown in FIG. 2. In another embodiment, hinges 105 may comprise multiple spaced-apart hinges that only extend along a portion of the width of the multi-segment panel. In yet another embodiment, hinges 105 may comprise slip hinges to allow the panel segments 102, 103, 104 to be selectively folded against one another or to be completely detached from one another. In still another embodiment, hinges 105 may comprise one or more sheets of flexible material attached to adjacent panel segments 102, 103, 104.

The cargo management system 100 includes a number of hard mounts 106 adapted to receive straps or the like (not shown) for securing large, heavy, and/or irregularly shaped items. In some embodiments, the hard mounts 106 may comprise a straight member fixed within a recess 107. In other embodiments, such as the one depicted in FIG. 2, the hard mounts 106 may comprise a rod with a U-shaped portion that is pivotably mounted in a recess 107 in one of the panel segments 102, 103, 104 such that the U-shaped portion of the rod may be positioned to extend upwardly during use, or positioned generally within the associated recess 107 when not in use. In yet another embodiment, one or more apertures (not shown) may be provided in the panel segments 102, 103, 104 that are positioned to correspond with permanent vehicle hard mounts of a particular vehicle, such that the permanent vehicle hard mounts may be used in conjunction with the removable multi-segment panel to secure large, heavy, and/or irregularly shaped items.

Handle apertures 110 are provided in the panel segments 102, 103, 104. The handle apertures 110 are positioned to generally align when the multi-segment panel is folded to facilitate carrying the multi-segment panel, e.g., for installation, removal, and storage.

Strips or sheets of attachment material 112 are provided on the top surface of the panel segments 102, 103, 104. In one embodiment, the strips 112 include one side of a common hook-and-loop fastener, such as strips of VELCRO® or the like. In one embodiment, the strips 112 are oriented generally longitudinally along the multi-segment panel to avoid or reduce interference with pushing cargo 92 from a receiving end of the vehicle 90 toward the opposite end. The removable chocks 120 are selectively positionable on the multi-segment panel and are releasably secured to the strips 112.

FIG. 3 illustrates a perspective view of an exemplary embodiment of a removable chock 120. The chock 120 comprises a generally rectilinear block 122 having attachment material 124 on one (or more) surfaces. The attachment material 124 is configured to be releasably attachable to the strips 112. For example, in one embodiment, the attachment material 124 comprises the hooks side of a hook-and-loop fastener, and the strips 112 comprise the corresponding loops side of the hook-and-loop fastener. The chocks 120 may therefore be selectively placed and removably secured to the strips 112 to secure items such as the cargo package 92, and to prevent shifting of the cargo package 92 during travel. Although simple rectilinear chocks 120 are shown, it will be appreciated that other shapes and sizes are possible and may provide advantages for particular applications. For example, one or more elongated chocks may be provided that are long enough to engage more than one of the strips 112. It is contemplated that the cargo management system 100 may be provided with a set of chocks having different shapes and sizes to provide greater flexibility to the user.

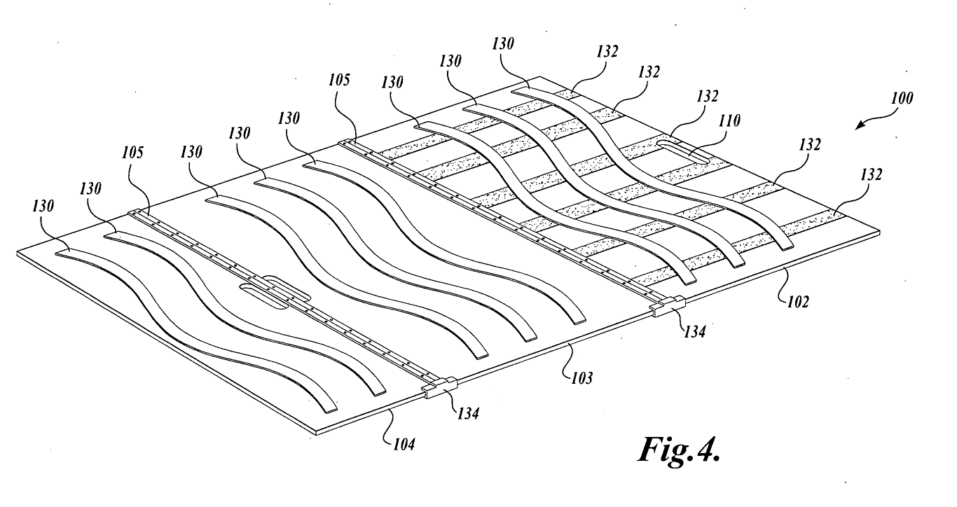

FIG. 4 shows the bottom surface of the cargo management system 100. The bottom surfaces of the panel segments 102, 103, 104 are provided with one or more strips 130 of a skid-resistant material. The skid-resistant material may be, for example, rubber, soft plastic, bristled material, and so on. The strips 130 are adapted to engage the surface of the cargo area 91 of the vehicle 90 to prevent or reduce any tendency of the multi-segmented panel to shift during travel. In some embodiments, one side of hook-and-loop fastener strips 132 may be provided on the bottom surface of one or more of the panel segments 102, 103, 104, either in conjunction with the strips 130 or by themselves. The hook-and-loop fastener strips 132 are adapted to engage with a carpet or fabric covering of the cargo area 92, to further prevent or reduce movement of the multi-segment panel with respect to the vehicle 90.

In some vehicles, a seat well or depression (not shown) on the floor might interfere with the level placement of the multi-segment panel, or may be shaped in such a way as to not provide adequate support for the multi-segment panel. In some embodiments of the cargo management system 100, one or more custom-sized blocks or similar devices (not shown) may be selectively attached to the bottom surface of the multi-segment panel or placed in the depression to provide full support for the multi-segmented panel despite the irregular shape to the particular vehicle floor. For example, the one or more larger blocks may include the other side of hook-and-loop fasteners, such that the blocks may be removably attached to the hook-and-loop fastener strips 132.

The cargo management system 100 is preferably customized to fit in the enclosed cargo area of a vehicle 90. To use the cargo management system 100, the multi-segmented panel is unfolded and placed bottom-side down in the vehicle 90. In one embodiment, U-shaped hinge locking members 134 such as pivotable hooks, clips, or brackets, may be attached at the junctures of the adjacent panel segments 102, 103, 104, once unfolded, to lock the panel segments 102, 103, 104 in the deployed position.

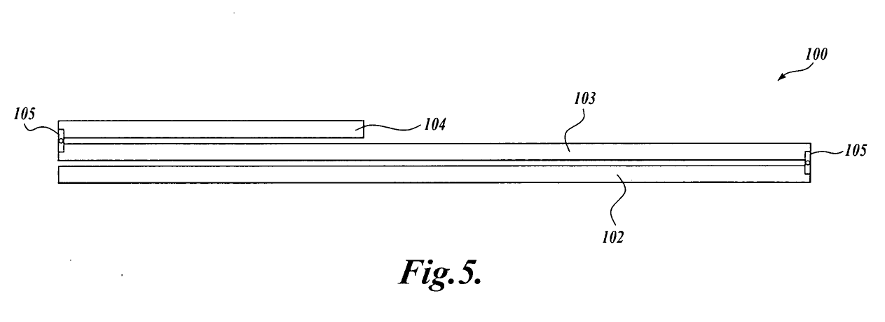

FIG. 5 illustrates a side view of the multi-segment panel in a folded state. The hinges 105 allow the panel segments 102, 103, 104 to be folded back on one another such that the cargo management system 100 may be stored in a space of substantially the same width and height as the largest of the panel segments. The hinges 105 may be mounted to connect panel segment 102 to panel segment 103, and to connect panel segment 103 to panel segment 104, such that when the panel segments are unfolded, the hinges 105 do not protrude from the upper surface of the cargo management system 100, thus preserving the smooth, flat, level surface.

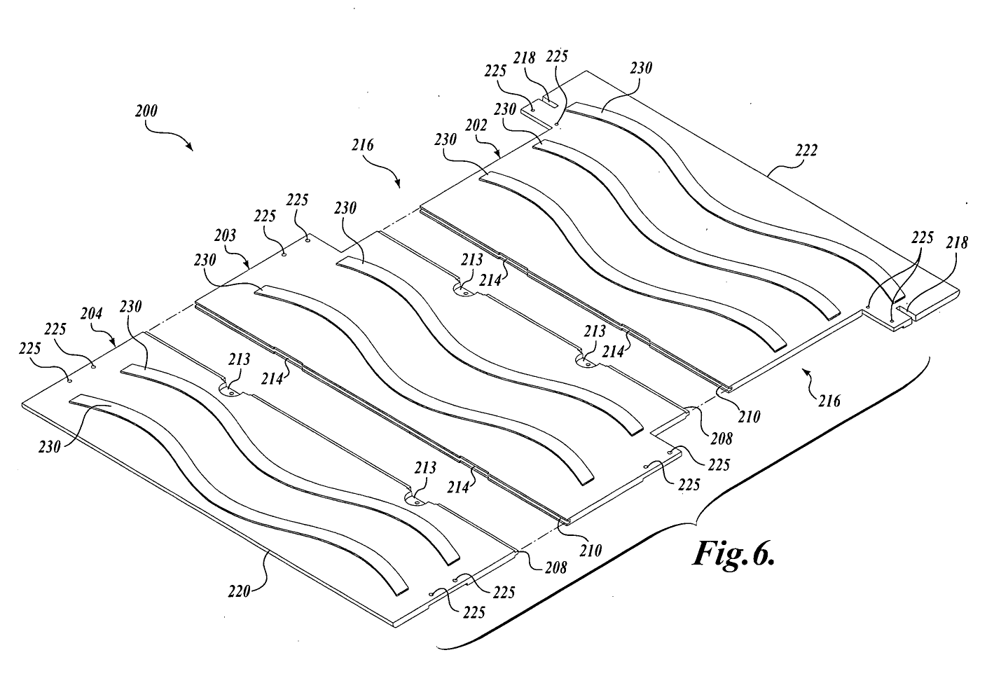

FIG. 6 illustrates an exploded perspective view of a bottom side of a second exemplary embodiment of a cargo management system 200 having detachable panel segments 202, 203, 204. In some embodiments, the material used to construct the panel segments 202, 203, 204 may render the entire combination too unwieldy or heavy to be easily installed and removed. Therefore, in some embodiments, the panel segments 202, 203, 204 are configured to be removably attached to one another. This allows a user to install or remove one panel segment at a time, thus reducing the size of the part the user would have to manipulate at any one time. Use of multiple detachable panels 202, 203, 204 also facilitates use of the cargo management system 200 in various alternate seating configurations in vehicles with removable or retractable seating.

Detachable panel segment 202 has an edge that contains a groove 210, while a neighboring detachable panel segment 203 has a corresponding edge that contains a tongue 208, wherein the tongue 208 and groove 210 are adapted to mesh when panel segment 202 and panel segment 203 are attached to one another. A similar groove 210 and tongue 208 are located on a second edge of panel segment 203, and a corresponding edge of panel segment 204, respectively. These tongue and groove joints provide added strength to the assembled cargo management system 200. In other embodiments, the panel segments 202, 203, 204 abut at a flat surface, or at a surface of different cross section.

As discussed further below, locking mechanisms releasably secure the detachable panel segments 202, 203, 204 to one another. Recesses 213 are adapted to receive a male portion of the lock mechanism, and notches 214 are adapted to receive a strike plate. Skid-resistant strips 230 similar to the skid-resistant strips 130 discussed above are attached to the bottom of the panel segments 202, 203, 204.

In some embodiments, the shape of the detachable panel segments 202, 203, 204 may be customized to fit a particular model vehicle. For example, when detachable panel segment 203 and detachable panel segment 202 are assembled, cutouts on the lateral edges of the panel segments form seat track recesses 216 to accommodate the seat tracks of a particular model vehicle. As another example, panel segment 202 may include slots 218 adapted to permit access to a hard point present in the cargo area 91 of the particular model vehicle. A front edge 220 and a rear edge 222 may also be rounded. One will appreciate that these adaptations may be present in any embodiment of the cargo management system, including embodiments comprising folding panel segments and embodiments comprising detachable panel segments.

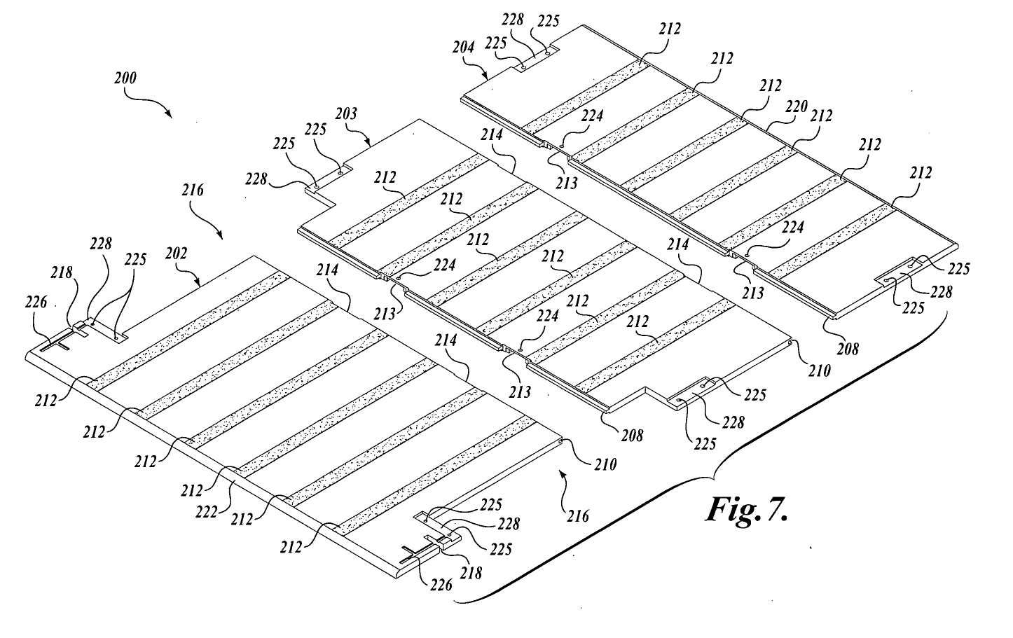

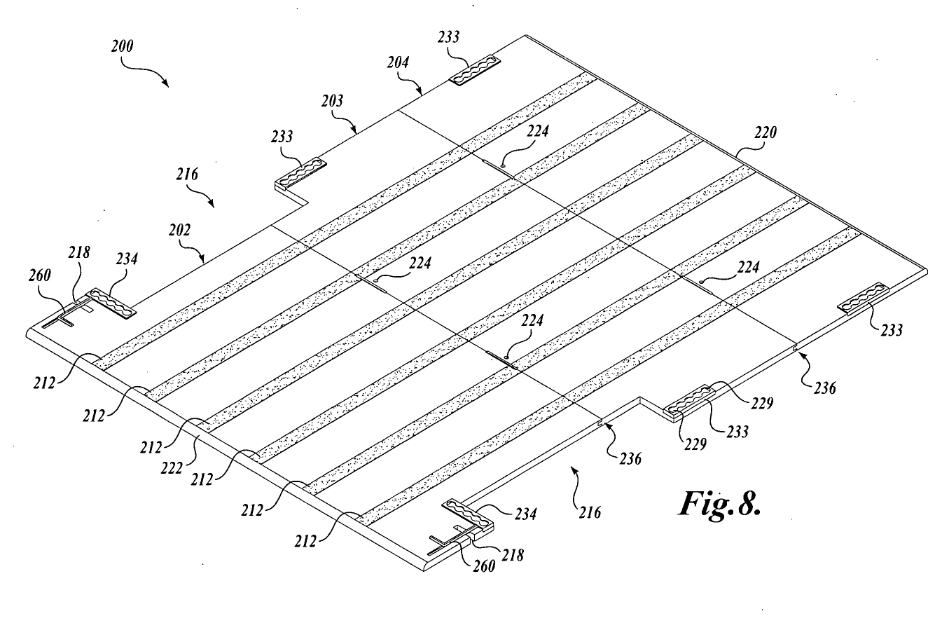

FIG. 7 illustrates an exploded perspective view of a top side of the cargo management system 200. The panel segments 202, 203, 204 include access ports 224 to allow access to the locking mechanism. After two adjacent panel segments 202, 203, 204 are assembled, a user inserts a hex wrench 260 (FIG. 8) or other tool into the access ports 224 to secure the assembled panel segments to one another. Similar to the foldable embodiments discussed above, the top surface of the cargo management system 200 includes strips of attachment material 212. As discussed below, detachable panel segment 202 includes a tool recess 226 to provide convenient storage for the tool, and to permit use of the tool to positively lock the cargo management system 200 into a hard point in the cargo area 91.

More flexibility may be desired with respect to positioning hard points for securing cargo with ropes, straps, bungee cords, and so on, than may be possible with the fixed hard mounts 106 depicted in FIG. 2. Accordingly, in some embodiments, the panel segments 202, 203, 204 may be adapted to allow attachment of a mounting rail (FIG. 8) that provides a movable hard mount. One example of such a mounting rail is a CORE TRAX™ rail, such as those provided by Core Products USA, although other mounting rails could be used. Detachable panel segments 202, 203, 204 include rail recesses 228 and mounting holes 225 to allow the attachment of the mounting rails via appropriate hardware, such as t-nuts and bolts, or the like. The rail recesses 228 are cut to an appropriate depth in the detachable panel segments 202, 203, 204, such that the mounting rails are either substantially flush with the top surface of the detachable panel segments 202, 203, 204, or protrude slightly from the top surface. One will appreciate that mounting rails may be present in any embodiment of the cargo management system, including embodiments comprising folding panel segments and embodiments comprising detachable panel segments.

FIG. 8 illustrates a perspective view of an exemplary embodiment of an assembled cargo management system 200. Rails 233, 234 have been mounted to the detachable panel segments 202, 203, 204, via appropriate mounting hardware. Rails 233 are shown mounted longitudinally, and rails 234 are shown mounted transversely, to provide a variety of different options for locating hard mounts. Detachable panel segment 202 is shown aligned and mated with detachable panel segment 203 to form a tongue-and-groove joint 236. Detachable panel segment 203 is shown similarly mated with detachable panel segment 204 at tongue-and-groove joint 236.

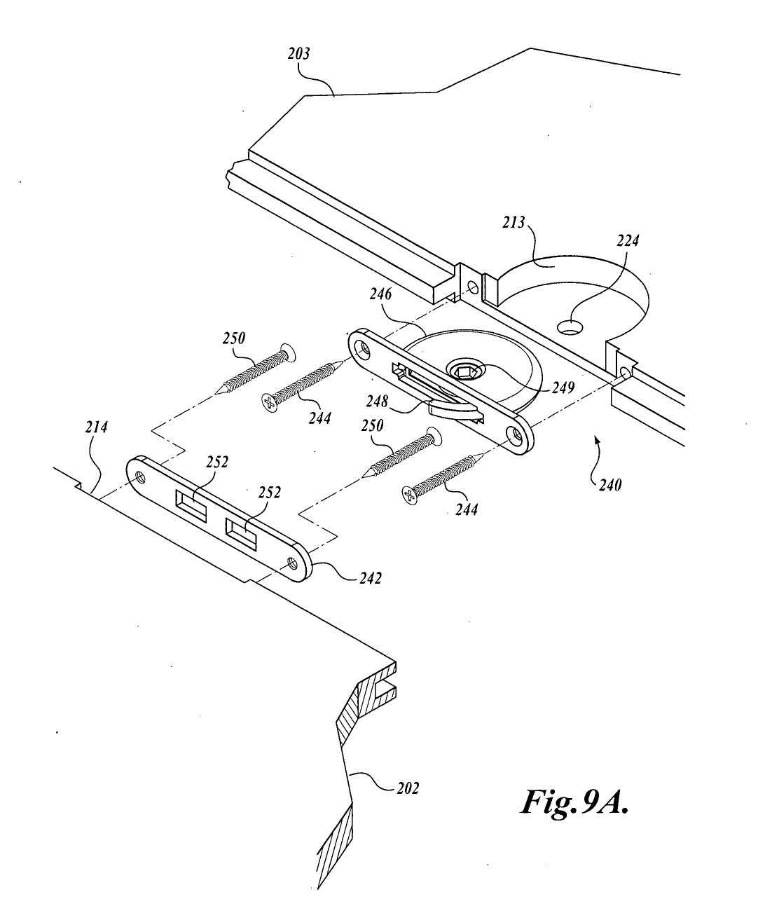

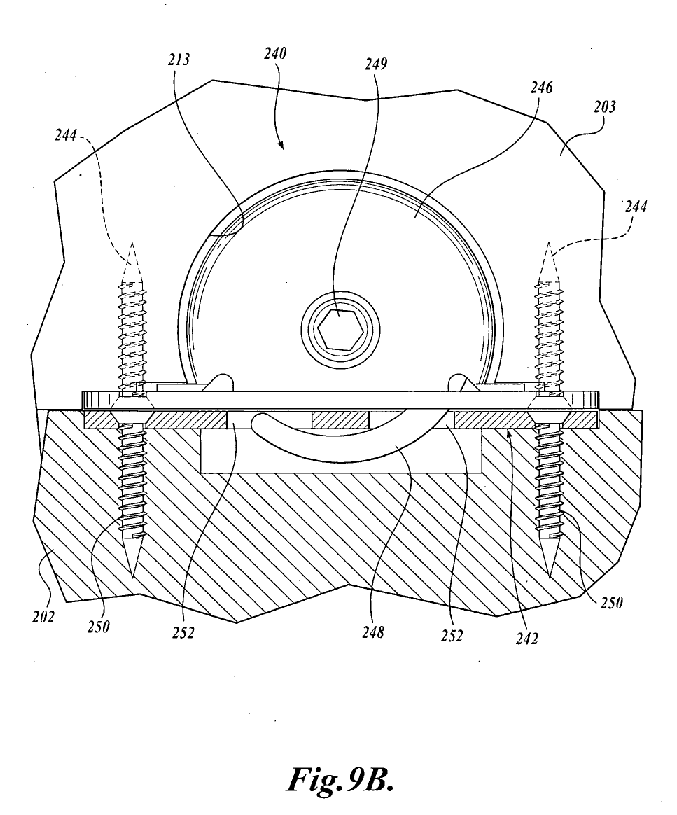

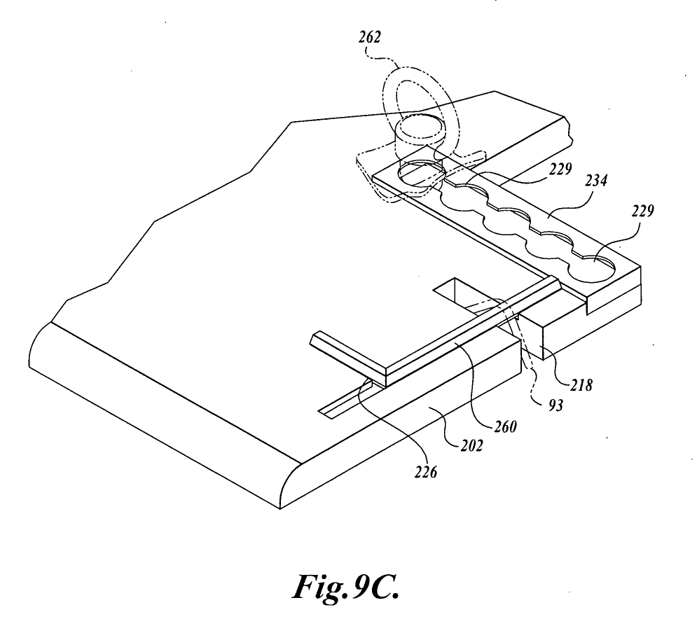

FIG. 9A is an exploded detail view of an exemplary giro-bolt lock-type locking mechanism having a male portion 240 and a female portion 242. While a giro-bolt lock-type locking mechanism is shown and described, other appropriate lock mechanisms may be used. The male portion 240 is adapted to fit within recess 213, and is mounted to the panel 203 via appropriate mounting hardware, such as mounting screws 244. The male portion 240 includes a lock body 246 and a movable latch 248 carried by the lock body 246. A keyed pivot 249 is provided within the lock body 246 and is accessible through the access port 224 when the male portion 240 is installed. The strike plate 242 is adapted to fit within the notch 214, and is mounted to the panel 202 via mounting screws 250. The strike plate 242 includes apertures 252 adapted to accommodate the movable latch 248 of the male portion 240.

FIG. 9B illustrates a partially cutaway detail view of the lock mechanism 240, 242 installed and engaged. As shown in the figure, the movable latch 248 extends through the apertures 252 and engages the strike plate 242, thereby locking the panels together.

FIG. 9C is a detail view showing the installed mounting rail 234. The tool recess 226 with a hex wrench tool 260 inserted therein is also shown. The hex wrench tool 260 is inserted through a vehicle hard point ring 93 which protrudes through the slot 218, thus positively locking the cargo management system 200 to the cargo area 91 to prevent movement. The mounting rail 234 fits within the rail mounting recess 228, and includes a plurality of positions 229 suitable for locating a movable hard mount 262. While an embodiment of a mounting rail 234 having a number of discrete positions 229 is illustrated, in other embodiments, a mounting rail may include a slidable member to allow even greater flexibility in positioning the movable hard point.

While illustrative embodiments have been illustrated and described, it will be appreciated that various changes can be made therein without departing from the spirit and scope of the invention.

The embodiments of the invention in which an exclusive property or privilege is claimed are defined as follows:

1. A cargo management system, comprising:
a plurality of panels that are interconnected to define a multi-segment panel;
a plurality of first portions of a releasable fastener, each of the releasable fastener first portions being affixed to a top surface of one of the plurality of panels;
a plurality of chocks;
a plurality of second portions of a releasable fastener, each of the releasable fastener second portions being affixed to a side of one of the plurality of chocks, wherein the second portions releasably adhere to the first portions of the releasable fasteners; and
a plurality of pieces of a skid-resistant material, each of the plurality of pieces affixed to a bottom surface of one of the plurality of panels;
such that the plurality of chocks may be positioned and releasably attached to the multi-segment panel.

2. The cargo management system of claim 1, wherein the plurality of panels are interconnected with hinges such that the multi-segment panel is positionable between a substantially planar deployed position and a folded position.

3. The cargo management system of claim 1, wherein the plurality of panels comprise wood panels.

4. The cargo management system of claim 1, wherein the plurality of panels are releasably interconnected, such that the plurality of panels may be assembled and disassembled in a vehicle.

5. The cargo management system of claim 4, wherein the plurality of panels are releasably interconnected with giro-bolt-type hardware.

6. The cargo management system of claim 4, wherein the plurality of panels comprise tongue and groove edge portions such that the when the plurality of panels are assembled the multi-segment panel comprises a substantially planar member without any gaps between adjacent panels.

7. The cargo management system of claim 4, wherein the multi-segment panel further comprises a plurality of hard mount rails fixedly attached to the multi-segment panel.

8. A cargo management system, comprising:
a multi-segment panel having a top surface, a bottom surface, and a length, the multi-segment panel comprising a plurality of hingedly connected panel segments and means for hingedly connecting the plurality of panel segments;
a plurality of chocks;
a first portion of a releasable fastener fixedly attached to each of the plurality of chocks;
a second portion of the releasable fastener fixedly attached to the top surface of the multi-segment panel, such that the plurality of chocks are selectively positionable on the top surface of the multi-segment panel; and
a skid-resistant material fixedly attached to the bottom surface of the multi-segment panel.

9. The cargo management system of claim 8, wherein the second portion of the releasable fastener extends along most of the length of the multi-segment panel.

10. The cargo management system of claim 8, wherein the skid-resistant material comprises one of rubber, soft plastic, and bristle material.

11. The cargo management system of claim 8, further comprising a plurality of hard mounts attached to the multi-segment panel.

12. The cargo management system of claim 8, wherein each hard mount of the plurality of hard mounts includes a U-shaped portion that is pivotably positionable within an associated recess.

13. The cargo management system of claim 8, further comprising releasable locking members that are positionable to lock the multi-segment panel in a deployed position.

14. A cargo management system, comprising:
a plurality of chocks, each chock having a side comprising a first portion of a hook-and-loop fastener;
a plurality of panel segments, each panel segment including:
a substantially smooth upper surface having strips of a second portion of a hook-and-loop fastener attached thereto such that the upper surface releasably engages the plurality of chocks; and
a lower surface having a skid-resistant material attached thereto; and
means for detachably connecting each of the plurality of panel segments to at least one other of the plurality of panel segment.

15. The cargo management system of claim 14, wherein at least one panel segment of the plurality of panel segments includes a mounting rail for attaching a movable hard point.

16. The cargo management system of claim 15, wherein the mounting rail is disposed in a recess in the at least one panel segment.

17. The cargo management system of claim 14, wherein the means for detachably connecting each of the plurality of panel segments comprises a lock body housing a rotatable latch disposed in a recess in one of the panel segments and a strike plate attached to another of the panel segments, the strike plate being positioned and configured to receive the rotatable latch.

18. The cargo management system of claim 17, wherein at least one panel segment of the plurality of panel segments includes a recess for holding a tool for rotating the rotatable latch.

19. The cargo management system of claim 18, wherein the recess is employed to positively lock the cargo management system to a hard point of the vehicle.

20. The cargo management system of claim 14, wherein the plurality of panel segments comprise edges defining tongue-and-groove joints, such that the tongue-and-groove joints engage when the panel segments are detachably connected.
